(19) United States
(12) Patent Application Publication
(10) Pub. No.: US 2018/0115232 A1
(43) Pub. Date: Apr. 26, 2018

(54) ACTUATOR

(71) Applicant: Azbil Corporation, Chiyoda-ku (JP)

(72) Inventor: Shigeru KAWASE, Chiyoda-ku (JP)

(73) Assignee: Azbil Corporation, Chiyoda-ku (JP)

(21) Appl. No.: 15/522,674

(22) PCT Filed: Oct. 9, 2015
(86) PCT No.: PCT/JP2015/078783

§ 371 Date: Jan. 10, 2018

(30) Foreign Application Priority Data
Oct. 28, 2014 (JP) 2014-219520
Jan. 30, 2015 (JP) 2015-017262

(51) Int. Cl. H02K 41/035; H02K 7/08

(52) U.S. Cl. CPC H02K 41/0356; H02K 7/08

(57) ABSTRACT

An actuator (202) includes a rod-shaped inner yoke (1) inserted through a cylindrical outer yoke (10); a support member that supports the outer yoke (10) so as to be linearly movable in an axial direction of the inner yoke (1); a first coil (2) and a second coil (3) wound around the inner yoke (1) with a gap provided between the first coil (2) and the second coil (3), the first coil (2) and the second coil (3) passing currents in mutually opposite directions; a first magnet array (11) provided on an inner peripheral part of the outer yoke (10) so as to face the first coil (2); and a second magnet array (12) provided on the inner peripheral part of the outer yoke (10) so as to face the second coil (3), magnetic poles of the second magnet array (12) being oriented in an opposite direction to magnetic poles of the first magnet array (11).

### TECHNICAL FIELD

The present invention relates to an actuator, particularly to a linear actuator attached to, for example, a robot that assembles components.

### BACKGROUND ART

Conventionally, robots have performed a variety of works involving an assembly of components using an end effector attached to its distal end portion. As an example of an actuator that drives an end effector, a linear actuator in which a movable portion is linearly movable relative to a fixed portion is used in some cases.

Examples of the linear actuator include a so-called “direct drive actuator”, which directly drives a movable portion without using a decelerator.

A direct drive actuator is capable of controlling operations at high speed and with high precision and enhancing its work range when linked with a robot. On the other hand, a direct drive actuator has problems in size reduction and high power output. Moreover, objects attachable to the distal end portion of a robot are limited to those within a specific weight range. Thus, actuators having a small size and high power output have been desired.

Direct drive actuators include a voice coil motor (VCM), in which only a coil reciprocates in a strong magnetic field generated by a permanent magnet, such as a neodymium magnet. A voice coil motor can be designed to have a small movable portion, but is more likely to have low power output per volume since the voice coil motor is a direct drive motor.

On the other hand, PTL 1 and PTL 2 each disclose a linear motor having a plurality of voice-coil linear motor units arranged side by side. With this structure, each of the linear motors of PTL 1 and PTL 2 is designed to have high power output while restricting the increase in volume.

### CITATION LIST

### Patent Literature

PTL 1: Japanese Unexamined Patent Application Publication No. 2004-282833
PTL 2: Japanese Patent No. 3683199

### SUMMARY OF INVENTION

### Technical Problem

The linear motor in PTL 1 is described with reference to FIGS. 8 and 9. The linear motor in PTL 1 includes two inner yokes 20a and 20b arranged side by side. A first coil 22a and a second coil 23a are wound around the inner yoke 20a with a gap 21a provided between the first coil 22a and the second coil 23a. A first coil 22b and a second coil 23b are wound around the inner yoke 20b with a gap 21b provided between the first coil 22b and the second coil 23b.

The inner yokes 20a and 20b are respectively inserted through first outer yokes 30a and 30b facing the first coils 22a and 22b. First magnets 31a and 31b are respectively provided on the inner peripheral parts of the first outer yokes 30a and 30b. The two first outer yokes 30a and 30b are fixed so as to be mutually magnetically coupled to each other.

The inner yokes 20a and 20b are respectively inserted through second outer yokes 32a and 32b facing the second coils 23a and 23b. Second magnets 33a and 33b are respectively provided on the inner peripheral parts of the second outer yokes 32a and 32b. The two second outer yokes 32a and 32b are fixed so as to be mutually magnetically coupled to each other.

The first outer yokes 30a and 30b and the second outer yokes 32a and 32b are coupled by four coupling portions 34.

The magnetic poles of the first magnet 31a and the second magnet 33b are oriented in the opposite direction to the magnetic poles of the first magnet 31b and the second magnet 33a. Also, the currents flowing through the first coil 22a and the second coil 23b flow in the opposite direction to the currents flowing through the first coil 22b and the second coil 23a.

In the linear motor in PTL 1, a repulsive force is generated if the first magnets 31a and 31b approach the second coils 23a and 23b, and a repulsive force is also generated if the second magnets 33a and 33b approach the first coils 22a and 22b. The repulsive forces degrade the linearity of generated thrust characteristics with respect to the input current or the position of the movable portion in the axial direction (hereinafter, referred to as “thrust linearity”).

Also, to restrict the influence of the repulsive forces, the gaps 21a, 21b between the first coils 22a, 22b and the second coils 23a, 23b are necessary to be expanded. Hence, the movable range of the movable portion including the first outer yokes 30a and 30b and the second outer yokes 32a and 32b may be limited, and the inner yokes 20a and 20b may be increased in size.

Further, in the linear motor in PTL 1, since the neighboring two first outer yokes 30a and 30b and the neighboring two second outer yokes 32a and 32b form main magnetic paths ϕ1 and ϕ2, a yoke for turning the magnetic flux (so-called “return yoke”) is not necessary to be additionally provided, and hence the linear motor can be reduced in size as compared with a typical linear motor. However, the linear motor in PTL 1 has a width twice the width of a linear motor using a single inner yoke. The linear motor cannot be sufficiently reduced in size.

Furthermore, like PTL 1 and PTL 2, if a linear motor has a structure in which two inner yokes are housed in a fixed base having a closed-end box shape and the outer yokes are linearly movably supported by a slider at an opening of the fixed base (so-called “outer bearing structure”), the linear motor may be further increased in size.

The present invention is made to address the above-described problems, and it is an object to provide a further small and high efficient actuator.

### Solution to Problem

An actuator according to the present invention includes a single rod-shaped inner yoke inserted through a single cylindrical outer yoke; a support member that supports the outer yoke so as to be linearly movable in an axial direction of the inner yoke; a first coil and a second coil wound around the inner yoke with a gap provided between the first coil and the second coil, the first coil and the second coil passing currents in mutually opposite directions; a first magnet provided on an inner peripheral part of the outer yoke so as to face the first coil; and a second magnet provided on the inner peripheral part of the outer yoke so as to face the second coil, magnetic poles of the second magnet being oriented in an opposite direction to magnetic poles of the first magnet.

### Advantageous Effects of Invention

With the present invention, a further small and high efficient actuator can be obtained.

### BRIEF DESCRIPTION OF DRAWINGS

FIG. 1 is an exploded perspective view of an actuator according to a first embodiment of the present invention.

FIG. 2 is a perspective view of the actuator according to the first embodiment of the present invention.

FIG. 3 is a sectional view of the actuator illustrated in FIG. 2 taken along the plane A-B-C-D.

FIG. 4 is a perspective view of a fixed portion according to the first embodiment of the present invention.

FIG. 5 is a perspective view of a movable portion according to the first embodiment of the present invention.

FIG. 6(a) is a characteristic diagram of the magnetic flux density with respect to the coordinate of the actuator according to the first embodiment of the present invention in the axial direction. FIG. 6(b) is an explanatory view illustrating the distribution of the magnetic flux density of the actuator according to the first embodiment of the present invention.

FIG. 7(a) is an explanatory view illustrating a movable range of the actuator according to the first embodiment of the present invention. FIG. 7(b) is an explanatory view illustrating a movable range of an actuator subject to comparison not including a third coil.

FIG. 8 is a perspective view of a linear motor in PTL 2.

FIG. 9 is an explanatory view illustrating the distribution of the magnetic flux density of the linear motor in PTL 2.

FIG. 10 is an exploded perspective view of an actuator according to a second embodiment of the present invention.

FIG. 11 is a perspective view of the actuator according to the second embodiment of the present invention.

### DESCRIPTION OF EMBODIMENTS

To describe the invention in more detail, embodiments for implementing the invention are described below with reference to the accompanying drawings.

### First Embodiment

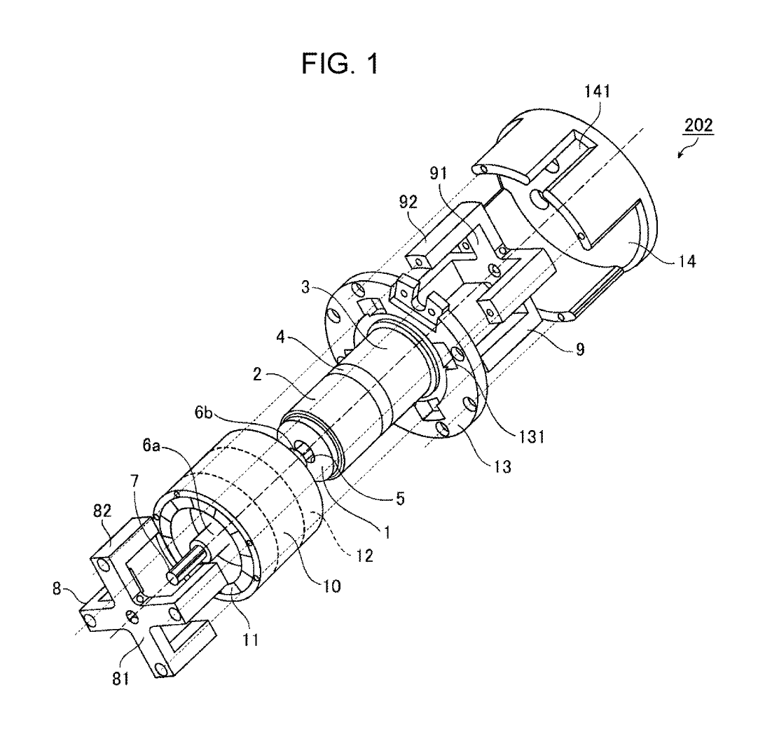

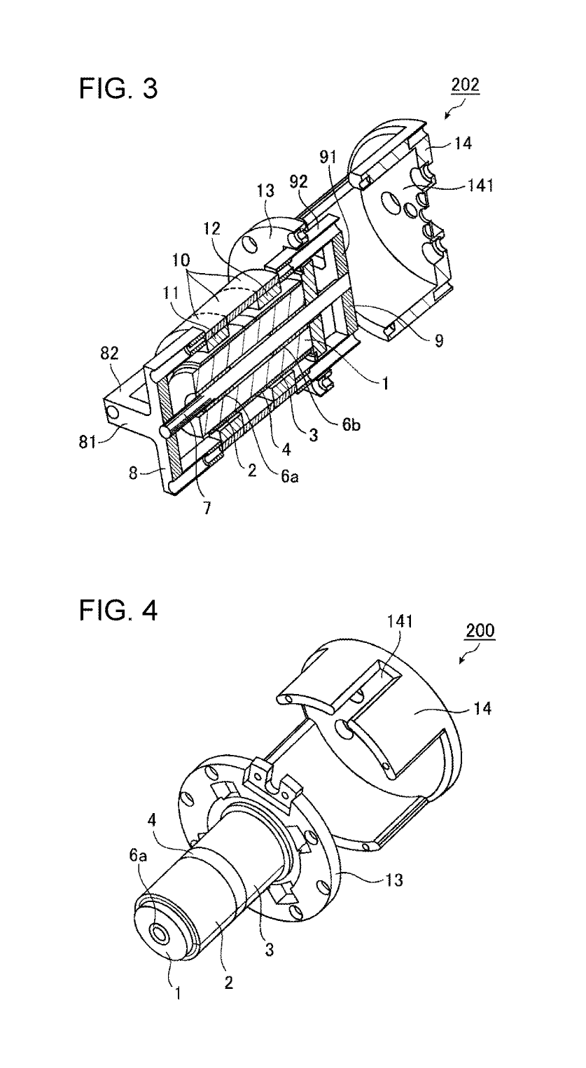

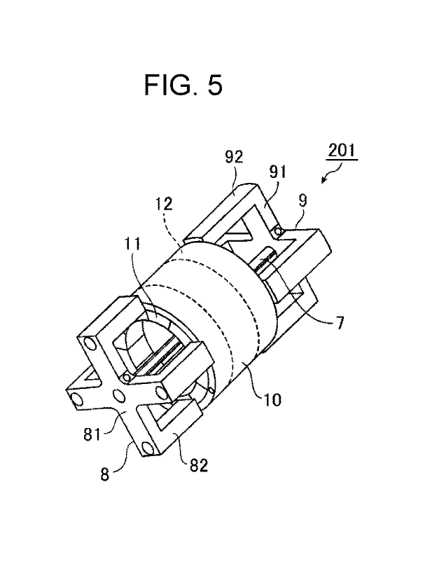

An actuator according to a first embodiment of the present invention is described with reference to FIGS. 1 to 5.

Throughout the drawings, reference sign 1 refers to a center yoke (inner yoke). The center yoke 1 is a magnetic body having a substantially rod shape.

A first coil 2 and a second coil 3 are wound around the center yoke 1 with a gap between the first coil 2 and the second coil 3. The first coil 2 and the second coil 3 are connected in series or parallel to a current source, not illustrated, and pass currents in mutually opposite directions.

A third coil 4 is wound in the gap between the first coil 2 and the second coil 3. The third coil 4 is connected to the current source with a switch controller, not illustrated, interposed between the third coil 4 and the current source. The direction of the current flowing through the third coil 4 is switchable independently of the directions of the currents flowing through the first coil 2 and the second coil 3.

A hollow bearing portion 5 extends along the axis of the center yoke 1. Bearing members 6a and 6b are inserted through both end portions of the bearing portion 5. A shaft 7 thinner than the center yoke 1 is inserted through hollow portions of the bearing members 6a and 6b. The shaft 7 is supported to be linearly movable in the axial direction relative to the center yoke 1 and rotatable or non-rotatable around the axis.

Here, the bearing members 6a and 6b are, for example, ball bushings when rendered rotatable or spline nuts when rendered non-rotatable. The center yoke 1 and the shaft 7 are thermally separated from each other by bearings of the bearing members 6a and 6b.

A top bridge (first bridge) 8 is fitted to and fixed to a first end portion of the shaft 7. A bottom bridge (second bridge) 9 is fitted to and fixed to a second end portion of the shaft 7. Each of the top bridge 8 and the bottom bridge 9 includes a substantially cross-shaped body 81 or 91 and four arms 82 or 92 extending from respective distal end portions of the cross-shaped body 81 or 91. The four arms 82 or 92 extend toward the opposing four arms 92 or 82. The shaft 7, the top bridge 8, and the bottom bridge 9 form a support member having an “inner bearing structure”.

An outer yoke 10 is fixed between distal end portions of the arms 82 of the top bridge 8 and distal end portions of the arms 92 of the bottom bridge 9. Specifically, the outer yoke 10 is supported to be linearly movable and rotatable or non-rotatable relative to the center yoke 1. The outer yoke 10 is formed of a substantially cylindrical magnetic body.

The shape of the bodies 81 and 91 is not limited to a cross shape. The number of the arms 82 or 92 is not limited to four. The top bridge 8 and the bottom bridge 9 may have any other shape with which it supports the outer yoke 10 so as to be at least linearly movable.

A first magnet array (first magnet) 11 is provided over the entire circumference of the inner peripheral part at a first end portion of the outer yoke 10. The first magnet array 11 is constituted of multiple permanent magnets. The first magnet array 11 faces the first coil 2 with a gap provided between the first magnet array 11 and the first coil 2. The first magnet array 11 also faces the third coil 4 depending on the position of the outer yoke 10 after a linear movement.

A second magnet array (second magnet) 12 is provided over the entire circumference of the inner peripheral part at a second end portion of the outer yoke 10. The second magnet array 12 is constituted of multiple permanent magnets. The second magnet array 12 faces the second coil 3 with a gap provided between the second magnet array 12 and the second coil 3. The second magnet array 12 also faces the third coil 4 depending on the position of the outer yoke 10 after a linear movement.

Here, the first magnet array 11 and the second magnet array 12 have magnetic poles oriented in mutually opposite directions. For example, the first magnet array 11 has the north pole on the surface contacting the outer yoke 10 and the south pole on the surface facing the first coil 2 and the third coil 4. On the other hand, the second magnet array 12 has the south pole on the surface contacting the outer yoke 10 and the north pole on the surface facing the second coil 3 and the third coil 4.

A flange-shaped bottom plate 13 is fixed to a first end portion of the center yoke 1. The bottom plate 13 has four through holes 131 through which the arms 92 of the bottom bridge 9 are slidably inserted.

A closed-end cylindrical attachment jig 14 is fixed to the bottom plate 13 so as to cover the bottom bridge 9. A bottom portion 141 of the attachment jig 14 is attachable to an external device, such as a distal end portion of a robot that assembles components.

The center yoke 1, the first coil 2, the second coil 3, the third coil 4, the bearing members 6a and 6b, the bottom plate 13, and the attachment jig 14 form a fixed portion 200. The shaft 7, the top bridge 8, the bottom bridge 9, the outer yoke 10, the first magnet array 11, and the second magnet array 12 form a movable portion 201. The fixed portion 200 and the movable portion 201 form an actuator 202.

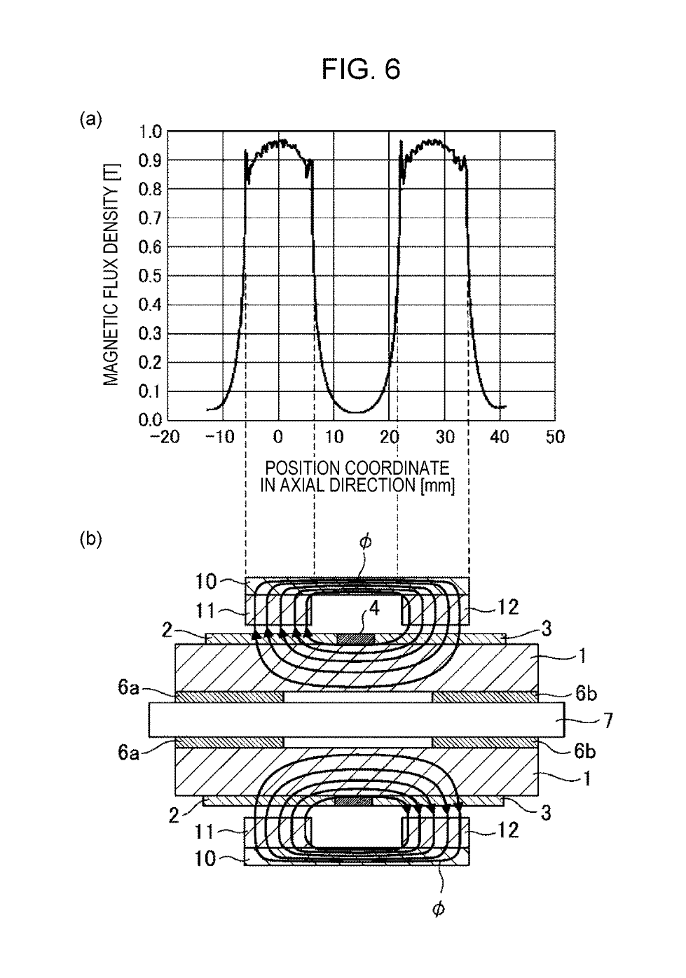

Now, the distribution of the magnetic flux density of the actuator 202 is described with reference to FIG. 6.

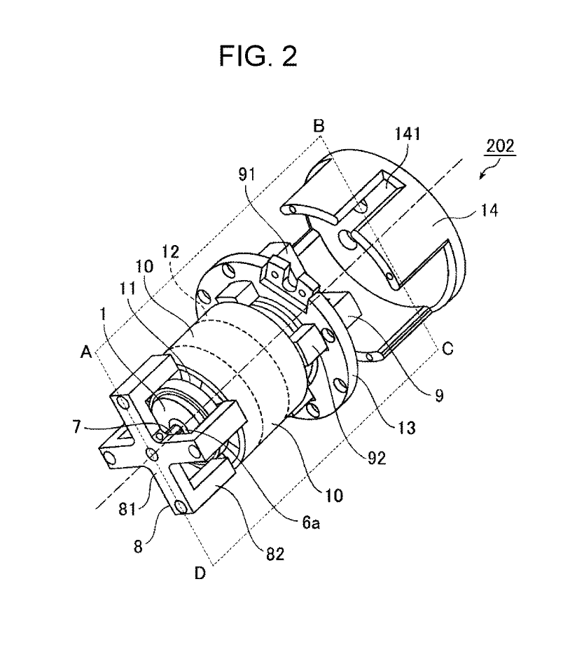

FIG. 6(a) is a characteristic diagram of the magnetic flux density of the first magnet array 11 and the second magnet array 12 with respect to the position coordinate of the movable portion 201 in the axial direction. FIG. 6(b) illustrates magnetic flux ϕ generated by the first magnet array 11 and the second magnet array 12 in a cross section of the actuator 202 taken along the surface A-B-C-D of FIG. 2.

As illustrated in FIG. 6(b), the magnetic flux ϕ generated by the first magnet array 11 and the second magnet array 12 is looped magnetic flux that passes the entire circumference of the outer yoke 10 and the inside of the center yoke 1.

A typical voice coil motor separately includes, besides the center yoke 1 and the outer yoke 10, a return yoke that turns the magnetic flux to form looped magnetic flux. Although having a structure including two motors connected in series, a return yoke may be omitted from the actuator 202 according to the first embodiment because the center yoke 1 and the outer yoke 10 turn the magnetic flux. This structure allows size reduction of the actuator 202.

Providing the first magnet array 11 and the second magnet array 12 over the entire circumference at both end portions of the outer yoke 10 renders the entire circumference of the outer yoke 10 to be usable as a magnetic circuit and reduces the magnetic resistance. The actuator 202 having this structure can thus reduce the thickness of the outer yoke 10 and have a smaller weight.

A center portion of the center yoke 1 has low magnetic flux density and thus has only a small contribution to formation of the magnetic circuit. Providing the hollow bearing portion 5 at the axis of the center yoke 1 thus does not significantly reduce the efficiency of the actuator 202. The actuator 202 having an inner bearing structure constituted of the shaft 7, the top bridge 8, and the bottom bridge 9 can thus have a smaller size than an existing linear motor having an outer bearing structure constituted of a fixed base and a slider without reducing the efficiency.

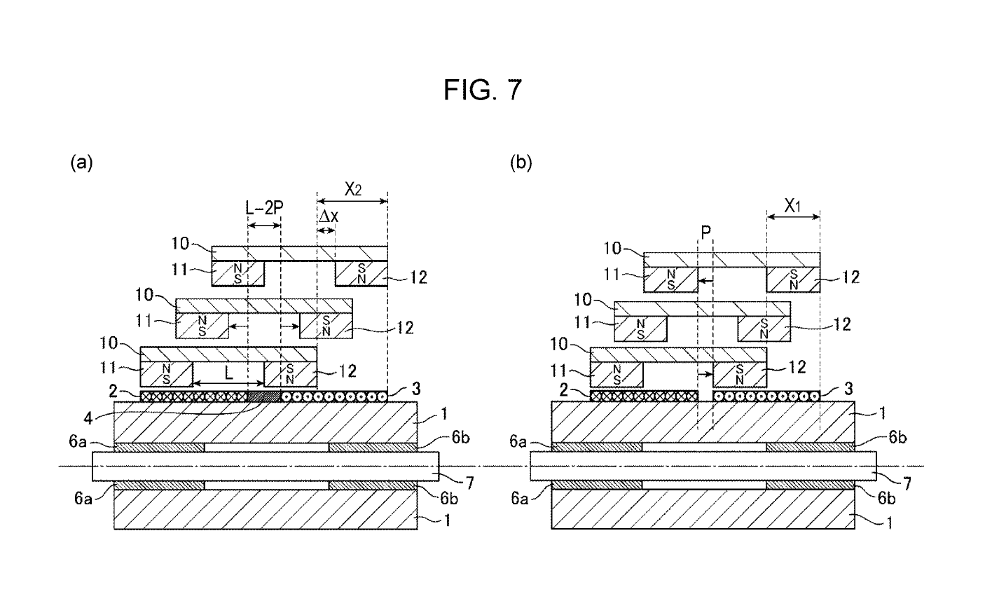

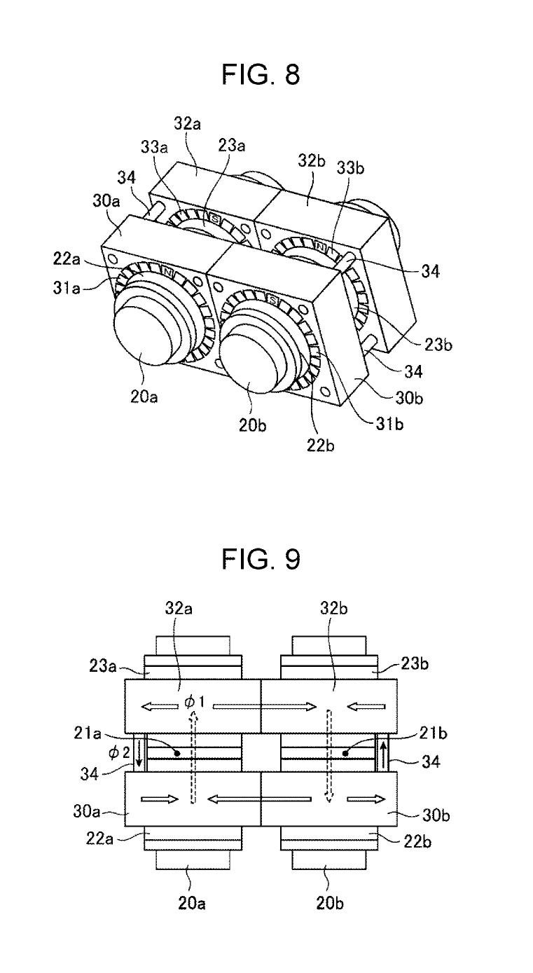

Now, the movable range of the linear movement of the actuator 202 is described with reference to FIGS. 6 and 7.

As illustrated in FIG. 6(a), the magnetic flux leaking from a side portion of the first magnet array 11 increases the magnetic flux density to about 0.05 to 0.5 tesuras (T) in the range of the position coordinate in the axial direction of about −10 to −6 millimeters (mm) and in the range of about +6 to +10 mm. Similarly, the magnetic flux leaking from the side portion of the second magnet array 12 increases the magnetic flux density to about 0.05 to 0.5 T in the range of the coordinate in the axial direction of about +18 to +22 mm and in the range of about +34 to +38 mm.

FIG. 7(b) illustrates the movable range of an actuator subject to comparison not including the third coil 4 illustrated in FIGS. 1 to 5. When the first magnet array 11 approaches the second coil 3 depending on the linear movement of the actuator, the magnetic flux leaking from the side portion of the first magnet array 11 generates a repulsive force in the axial direction between the first magnet array 11 and the second coil 3. Similarly, when the second magnet array 12 approaches the first coil 2, the magnetic flux leaking from the side portion of the second magnet array 12 generates a repulsive force in the axial direction between the second magnet array 12 and the first coil 2.

Typically, the first coil 2 and the second coil 3 are connected in series or parallel to the same current source, and the directions in which currents flow through the first coil 2 and the second coil 3 cannot be independently controlled. Hence, particularly at the position at which the first magnet array 11 approaches the second coil 3, and at the position at which the second magnet array approaches the first coil 2, the repulsive forces may degrade the thrust linearity of the actuator.

Moreover, in order to reduce the influence of the repulsive forces, the width of the gap between the first coil 2 and the second coil 3 is necessary to be increased by a certain degree not to cause the influence to become a problem in practical use. The large gap may limit the movable range of the movable portion 201, and increase the size of the fixed portion 200.

In contrast, as illustrated in FIG. 7(a), the actuator 202 according to the first embodiment includes the third coil 4 provided between the first coil 2 and the second co 3. Here, when reference sign L represents a length of the gap in the axial direction between the first magnet array 11 and the second magnet array 12, and P represents a width in the axial direction of a region where a repulsive force is generated by the magnetic flux leaking from one side portions of the first magnet array 11 and the second magnet array 12, the width in the axial direction of the third coil 4 is set at L−2P.

When the first magnet array 11 approaches the third coil 4 from the first coil 2 side, and the width of the gap between the first magnet array 11 and the third coil 4 becomes a predetermined value or smaller (in the example in FIG. 7(a), when the distance between the first magnet array 11 and the third coil 4 becomes equivalent to the distance between the second magnet array 12 and the third coil 4), a switch controller, not illustrated, switches the direction of the current flowing through the third coil 4 to the same direction as the direction of the current flowing through the first coil 2. With the switching, the outer yoke 10 can move to the region where the first magnet array 11 faces the third coil 4 while the repulsive force between the first magnet array 11 and the second coil 3 is restricted.

When the second magnet array 12 approaches the third coil 4 from the second coil 3 side, and the width of the gap between the second magnet array 12 and the third coil 4 becomes a predetermined value or smaller (in the example in FIG. 7(a), when the distance between the second magnet array 12 and the third coil 4 becomes equivalent to the distance between the first magnet array 11 and the third coil 4), a switch controller, not illustrated, switches the direction of the current flowing through the third coil 4 to the same direction as the direction of the current flowing through the second coil 3. With the switching, the outer yoke 10 can move to the region where the second magnet array 12 faces the third coil 4 while the repulsive force between the second magnet array 12 and the first coil 2 is restricted.

By switching the direction of the current flowing through the third coil 4 in this way depending on the position in the axial direction of the outer yoke 10, the movable range in the linear movement direction of the outer yoke 10 can be expanded. A movable range X2 of the actuator 202 according to the first embodiment illustrated in FIG. 7(a) is expanded by a difference ΔX with respect to a movable range X1 of the actuator subject to comparison illustrated in FIG. 7(b).

As described above, the actuator 202 according to the first embodiment includes the single rod-shaped center yoke 1 inserted through the single cylindrical outer yoke 10; the support member that supports the outer yoke 10 so as to be linearly movable in the axial direction of the center yoke 1; the first coil 2 and the second coil 3 wound around the center yoke 1 with the gap provided between the first coil 2 and the second coil 3, the first coil 2 and the second coil 3 passing the currents in the mutually opposite directions; the first magnet array 11 provided on the inner peripheral part of the outer yoke 10 so as to face the first coil 2; and the second magnet array 12 provided on the inner peripheral part of the outer yoke 10 so as to face the second coil 3, the magnetic poles of the second magnet array 12 being oriented in the opposite direction to the magnetic poles of the first magnet array 11. With this structure, the actuator 202 that increases the operation efficiency of the actuator 202, that does not require a return yoke, and that is further reduced in size can be obtained.

Also, the first magnet array 11 is provided over the entire circumference of the inner peripheral part at the first end portion of the outer yoke 10, and the second magnet array 12 is provided over the entire circumference of the inner peripheral part at the second end portion of the outer yoke 10. With this structure, since the entire circumference of the outer yoke 10 is used for a magnetic circuit, the magnetic resistance can be reduced.

Also, the actuator 202 includes the hollow bearing portion 5 extending along the axis of the center yoke 1. The support member includes the shaft 7 inserted through the bearing portion 5 and supported so as to be linearly movable relative to the center yoke; the top bridge 8 fitted to the first end portion of the shaft 7 and contacting the first end portion of the outer yoke 10; and the bottom bridge 9 fitted to the second end portion of the shaft 7 and contacting the second end portion of the outer yoke 10. With this structure, the linear motor can be smaller than an existing linear motor that employs an outer bearing structure, without influence on the operation efficiency.

Also, the actuator 202 includes the third coil 4 wound in the gap between the first coil 2 and the second coil 3, and the switch controller that switches the direction of the current flowing through the third coil 4 depending on the position in the axial direction of the outer yoke 10. The switch controller switches the direction of the current in the third coil 4 to the same direction as the direction of the current in the first coil 2 when the distance between the first magnet array 11 and the third coil 4 becomes the predetermined value or smaller, and switches the direction of the current in the third coil 4 to the same direction as the direction of the current in the second coil 3 when the distance between the second magnet array 12 and the third coil 4 becomes the predetermined value or smaller. Accordingly, the movable range in the linear movement direction of the outer yoke 10 can be expanded. Also, the thrust linearity of the actuator 202 can be improved.

Also, the support member supports the outer yoke 10 so as to be rotatable or non-rotatable relative to the axis of the center yoke 1. The actuator 202 having this structure can thus have a small size and two degrees of freedom.

The shapes of the cross sections of the center yoke 1 and the outer yoke 10 are not limited to be circular. Particularly if the outer yoke 10 is supported so as to be non-rotatable, the shapes of the cross sections may be rectangular or triangular.

### Second Embodiment

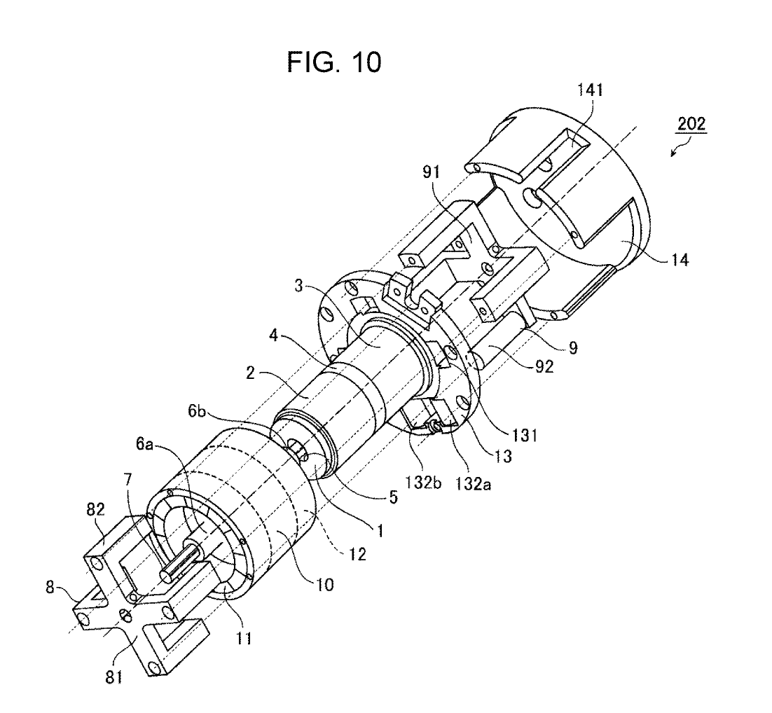

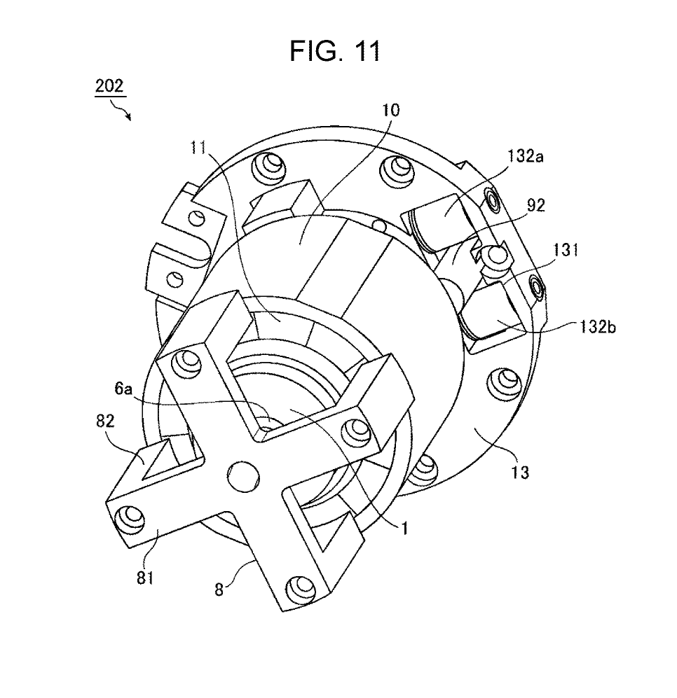

Referring to FIGS. 10 and 11, an actuator, which is small and highly efficient similarly to that of the first embodiment, and which also has increased structural strength, is described. In FIGS. 10 and 11, components the same as those of the actuator according to the first embodiment illustrated in FIGS. 1 to 5 are denoted with the same reference signs and not described.

Two mutually facing, cylindrical bearings 132a and 132b are rotatably attached to the through holes 131 of the bottom plate 13. An arm 92 of the bottom bridge 9 is substantially columnar, and is inserted through the gap between the bearings 132a and 132b.

The arm 92 of the bottom bridge 9 thus structured functions as a shaft that supports the movable portion 201 so as to be linearly movable relative to the fixed portion 200. Since the two shafts including the shaft 7 inserted through the center yoke 1 and the arm 92 inserted through the gap between the bearings 132a and 132b support the movable portion 201, the structural strength of the actuator 202 can be increased as compared with the structure only using the single shaft 7.

Also, the width of the gap between the two bearings 132a and 132b is slightly larger (for example, about 20 μm) than the diameter of the arm 92. When a force of causing the movable portion 201 to rotate around the shaft 7 relative to the fixed portion 200 (hereinafter, referred to as “torsion load”) is not applied, the gap is formed between the arm 92 and the bearings 132a, 132b. When the torsion load is applied, the arm 92 contacts one of the two bearings 132a and 132b and hence restricts the rotation of the movable portion 201 relative to the fixed portion 200.

In the first embodiment, if the bearing members 6a and 6b each use a ball spline, the strength of the actuator 202 against the torsion load (hereinafter, referred to as “torsion-resistance strength”) is determined by the limit values of the shaft 7 and the bearing members 6a and 6b. In the first embodiment, for example, the actuator 202 may be reduced in size and increased in efficiency by restricting the decrease in volume of the center yoke 1 by thinning the shaft 7. However, in this case, the limit value of the shaft 7 is decreased, and the torsion-resistance strength of the actuator 202 may be decreased.

Therefore, in the actuator 202 according to the second embodiment, when the torsion load is applied, the arm 92 contacts the bearing 132a or 132b, restricts the rotation of the movable portion 201, and causes the rotation angle of the shaft 7 with respect to the bearing members 6a and 6b to fall within an allowable range. That is, the width of the gap between the two bearings 132a and 132b is set at a width that causes the rotation angle of the shaft 7 to fall within the allowable range by the arm 92 contacting the bearing 132a or 132b depending on the rotation of the outer yoke 10. Accordingly, the torsion-resistance strength of the actuator 202 can be increased, and the problem which occurs when the shaft 7 is thinned as described above can be addressed.

As described above, the actuator 202 according to the second embodiment includes the bottom plate 13 provided at the second end portion of the center yoke 1, and the bearings 132a and 132b arranged so as to face each other in the through hole 131 of the bottom plate 13. The bottom bridge 9 includes the body 91 fitted to the second end portion of the shaft 7, and the arm 92 extending from the body 91 and contacting the second end portion of the outer yoke 10. The arm 92 is inserted through the gap between the bearings 132a and 132b. The arm 92 functions as a shaft, and hence the strength of the actuator 202 can be increased as compared with the structure using only the single shaft 7.

Moreover, the gap is formed between the arm 92 and the bearings 132a, 132b. The width of the gap between the two bearings 132a and 132b is set at a width that causes the rotation angle of the shaft 7 to fall within the allowable range by the arm 92 contacting the bearing 132a or 132b depending on the rotation of the outer yoke 10. Hence, the torsion-resistance strength of the actuator 202 can be increased while the volume of the center yoke 1 is reduced by thinning the shaft 7.

The arm of the bridge functioning as a shaft is not limited to one of the four arms 92 included in the bottom bridge 9. The bearings 132a and 132b may be attached to each of a plurality of through holes from among the four through holes 131 provided in the bottom plate 13. A plurality of arm portions from among the four arms 92 included in the bottom bridge 9 may function as shafts.

Moreover, the bottom plate may be provided at the end portion of the center yoke 1 near the top bridge 8, the bottom plate may have a through hole and bearings, and the arm of the top bridge 8 may function as a shaft.

The member functioning as a shaft is not limited to an arm of a bridge. The member may be any member as long as the member can restrict the rotation of the movable portion 201 when a torsion load is applied to the actuator 202. A bearing may be attached to a hole formed in any member of the fixed portion 200, and any member of the movable portion 201 may be inserted through the gap between the bearings.

Moreover, the mechanism that supports the arm functioning as the shaft is not limited to the two bearings 132a and 132b illustrated in FIGS. 10 and 11. Any mechanism may be employed as long as the mechanism supports the arm at two points.

Embodiments of the present invention can be freely combined within the scope of the invention or any of the components of each embodiment may be modified or omitted.

### REFERENCE SIGNS LIST

1 center yoke (inner yoke)
2 first coil
3 second coil
4 third coil
5 bearing portion
6a, 6b bearing member
7 shaft
8 top bridge (first bridge)
9 bottom bridge (second bridge)
10 outer yoke
11 first magnet array (first magnet)
12 second magnet array (second magnet)
13 bottom plate
14 attachment jig
20a, 20b inner yoke
21a, 21b gap
22a, 22b first coil
23a, 23b second coil
30a, 30b first outer yoke
31a, 31b first magnet
32a, 32b second outer yoke
33a, 33b second magnet
34 coupling portion
81 body
82 arm
91 body
92 arm
131 through hole
132a, 132b bearing
141 bottom portion
200 fixed portion
201 movable portion
202 actuator

1. An actuator, comprising:
a single rod-shaped inner yoke inserted through a single cylindrical outer yoke;
a support member that supports the outer yoke so as to be linearly movable in an axial direction of the inner yoke;
a first coil and a second coil wound around the inner yoke with a gap provided between the first coil and the second coil, the first coil and the second coil passing currents in mutually opposite directions;
a first magnet provided on an inner peripheral part of the outer yoke so as to face the first coil; and
a second magnet provided on the inner peripheral part of the outer yoke so as to face the second coil, magnetic poles of the second magnet being oriented in an opposite direction to magnetic poles of the first magnet.

2. The actuator according to claim 1,
wherein the first magnet is provided over an entire circumference of the inner peripheral part at a first end portion of the outer yoke, and
wherein the second magnet is provided over an entire circumference of the inner peripheral part at a second end portion of the outer yoke.

3. The actuator according to claim 1, further comprising:
a hollow bearing portion extending along an axis of the inner yoke,
wherein the support member includes
a shaft inserted through the bearing portion and supported so as to be linearly movable relative to the inner yoke,
a first bridge fitted to a first end portion of the shaft and contacting a first end portion of the outer yoke, and
a second bridge fitted to a second end portion of the shaft and contacting a second end portion of the outer yoke.

4. The actuator according to Claim I, further comprising:
a third coil wound in a gap between the first coil and the second coil; and
a switch controller that switches a direction of a current flowing through the third coil depending on a position in an axial direction of the outer yoke.

5. The actuator according to claim 4, wherein the switch controller switches the direction of the current in the third coil to a same direction as the direction of the current in the first coil when a distance between the first magnet and the third coil becomes a predetermined value or smaller, and switches the direction of the current in the third coil to a same direction as the direction of the current in the second coil when a distance between the second magnet and the third coil becomes a predetermined value or smaller.

6. The actuator according to claim 1, wherein the support member supports the outer yoke so as to be rotatable relative to an axis of the inner yoke.

7. The actuator according to Claim
wherein the outer yoke has a cross section being circular, rectangular, or triangular, and
wherein the inner yoke has a cross section being circular, rectangular, or triangular.

8. The actuator according to claim 3, further comprising:
a bottom plate provided at a second end portion of the inner yoke; and bearings arranged so as to face each other in a through hole of the bottom plate,
wherein the second bridge includes a body fitted to the second end portion of the shaft, and an arm extending from the body and contacting the second end portion of the outer yoke, and
wherein the arm is inserted through a gap between the bearings.

9. The actuator according to claim 8,
wherein a gap is formed between the arm and the bearings, and
a width of the gap between the bearings is set at a width that causes a rotation angle of the shaft to fall within an allowable range by the arm contacting the bearings depending on rotation of the outer yoke.
